(19) United States
(12) Patent Application Publication
(10) Pub. No.: US 2022/0045633 A1
(43) Pub. Date: Feb. 10, 2022

(54) APPARATUS AND METHOD FOR SENSING MOVEMENT INFORMATION OF ROTOR, AND ELECTRONIC DEVICE

(71) Applicant: Samsung Electro-Mechanics Co., Ltd., Suwon-si (KR)

(72) Inventor: Yong Wook KIM, Suwon-si (KR)

(73) Assignee: Samsung Electro-Mechanics Co., Ltd., Suwon-si (KR)

(21) Appl. No.: 17/077,458

(22) Filed: Oct. 22, 2020

(30) Foreign Application Priority Data
Aug. 10, 2020 (KR) 10-2020-0099709

(51) Int. Cl. H02P 6/16; H02K 11/33

(52) U.S. Cl. CPC H02P 6/16; H02K 11/33

(57) ABSTRACT

An apparatus for sensing movement of a rotor includes: a rotor configured to rotate along a rotation axis; a first electrode and a second electrode disposed to be spaced apart from each other and arranged to surround the rotation axis; and a conductive contact member disposed on the rotor and configured to contact the first and second electrodes as the rotor receives force in a direction different from a direction of the rotation axis.

### CROSS-REFERENCE TO RELATED APPLICATIONS

This application claims the benefit under 35 U.S.C. § 119(a) of Korean Patent Application No. 10-2020-0099709 filed on Aug. 10, 2020 in the Korean Intellectual Property Office, the entire disclosure of which is incorporated herein by reference for all purposes.

### BACKGROUND

### 1. Field

The following description relates to an apparatus for sensing movement of a rotor, and an electronic device including such an apparatus.

### 2. Description of Related Art

Recently, types and designs of electronic devices have been diversified. In addition, a variety of user demands for electronic devices are gradually increasing and, accordingly, requirements for the functions and designs of electronic devices are gradually increasing.

In this regard, an electronic device may be provided with a rotor to satisfy the various user demands based on various rotor movements and designs.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an apparatus for sensing movement of a rotor includes: a rotor configured to rotate along a rotation axis; a first electrode and a second electrode disposed to be spaced apart from each other and arranged to surround the rotation axis; and a conductive contact member disposed on the rotor and configured to contact the first and second electrodes as the rotor receives force in a direction different from a direction of the rotation axis contact member disposed on the rotor and configured to contact the first and second electrodes as the rotor receives force in a direction different from a direction of the rotation axis.

The first electrode may include a plurality of first electrodes spaced apart from each other. The second electrode may include a plurality of second electrodes spaced apart from each other. The plurality of first electrodes and the plurality of second electrodes may be alternately arranged with each other.

The plurality of first electrodes may have shapes extending in directions facing each other from different positions. The plurality of second electrodes may have shapes extending in directions facing each other from different positions.

A distance between first ends of adjacent first and second electrodes among the plurality of first electrodes and the plurality of second electrodes may be greater than a diameter of the conductive contact member. A distance between corresponding points of respective side surfaces of the adjacent first and second electrodes that face each other may be less than or equal to the diameter of the conductive contact member.

Each of the plurality of first electrodes may be wedge-shaped, and each of the plurality of second electrodes may be wedge-shaped.

The apparatus may further include a housing forming a space in which the first electrode and the second electrode are disposed, and having a through-hole through which the rotor penetrates.

The rotor may include a shaft disposed to penetrate through the through-hole, and a head disposed at one end of the shaft and configured to receive external force. The conductive contact member may be disposed at another end of the shaft.

The conductive contact member may be disposed to surround the other end of the shaft.

The apparatus may further include a fixing member disposed in the through-hole and configured to prevent movement of the shaft in the direction of the rotation axis.

The conductive contact member may be further configured to contact the first and second electrodes at a same time as the rotor receives the force in the direction different from the direction of the rotation axis

In another general aspect, an electronic device includes: a main body; a rotor disposed on one surface of the main body and having a rotation axis extending toward the main body; a first electrode and a second electrode disposed to be spaced apart from each other and arranged to surround the rotor; a conductive contact member disposed on the rotor and configured to contact the first and second electrodes at a same time as the rotor receives force in a direction different from a direction of the rotation axis; and a processor disposed in the main body and configured to generate information dependent on an electrical connection state between the first and second electrodes.

The main body may include a display surface for outputting display information. The one surface of the main body may be configured to have a normal direction different from a normal direction of the display surface.

At least a portion of the display information may be based on the information dependent on the electrical connection state between the first and second electrodes.

The electronic device may further include a fixing member disposed on the main body and configured to prevent the movement of the rotor in the direction of the rotation axis.

The electronic device may further include a sensing coil disposed such that an inductance varies according to a rotation angle of the rotor. The processor may be further configured to generate information dependent on the rotation angle of the rotor based on the inductance.

The first electrode may include a plurality of first electrodes spaced apart from each other. The second electrode may include a plurality of second electrodes spaced apart from each other. The plurality of first electrodes and the plurality of second electrodes may be alternately arranged with each other.

A distance between first ends of adjacent first and second electrodes among the plurality of first electrodes and the plurality of second electrodes may be greater than a diameter of the conductive contact member. A distance between corresponding points of respective side surfaces of the adjacent first and second electrodes that face each other may be less than or equal to the diameter of the conductive contact member.

The first electrode and the second electrode may be wedge-shaped.

The conductive contact member may be configured to be moved between the first and second electrodes as the rotor receives the force. The first and second electrodes may be configured to limit a distance the conductive contact member is moved between the first and second electrodes.

Other features and aspects will be apparent from the following detailed description, the drawings, and the claims.

### BRIEF DESCRIPTION OF DRAWINGS

FIG. 1 is a view illustrating a rotor, according to an embodiment.

FIG. 2 is a view illustrating an arrangement of first and second electrodes of a rotor movement sensing apparatus, according to an embodiment.

FIG. 3 is a view illustrating contact with the first and second electrodes according to the movement of a rotor of the rotor movement sensing apparatus, according to an embodiment.

FIGS. 4 and 5 are views illustrating a direction of movement of the rotor of the rotor movement sensing apparatus, according to an embodiment.

FIG. 6 is a view illustrating a structure for generating information dependent on an electrical connection state between the first and second electrodes of the rotor movement sensing apparatus and an electronic device, according to an embodiment.

FIGS. 7 and 8 are views illustrating contact with the first and second electrodes of the rotor movement sensing apparatus, and an electronic device, according to an embodiment.

FIGS. 9A and 9B are views illustrating an electronic device, according to an embodiment.

FIGS. 10A and 10B are views illustrating a rotor movement and rotation angle detecting apparatus of an electronic device, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Herein, it is noted that use of the term “may” with respect to an embodiment or example, e.g., as to what an embodiment or example may include or implement, means that at least one embodiment or example exists in which such a feature is included or implemented while all examples and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after gaining an understanding of the disclosure of this application. Further, although the examples described herein have a variety of configurations, other configurations are possible as will be apparent after an understanding of the disclosure of this application.

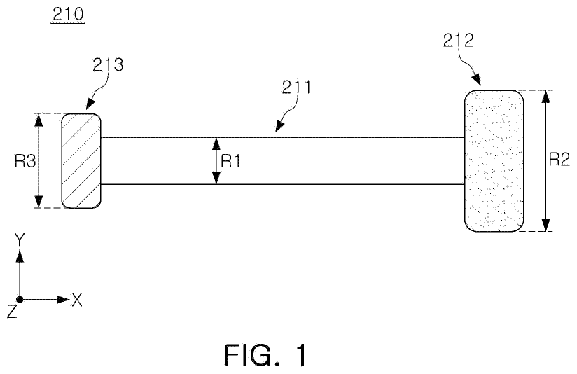

FIG. 1 is a view illustrating a rotor 210, according to an embodiment.

Referring to FIG. 1, the rotor 210 may be configured to rotate along a rotation axis (X axis), and may include a shaft 211, a head 212, and a metal contact member 213. For ease of reference, the following description will refer to element 213 as a metal contact member, but is to be understood that the element 213 may be embodied by a conductive contact member made of any suitably rigid conductive material.

For example, the shaft 211 may have a cylindrical shape extending along the rotation axis (X axis), may be made of an insulating material (e.g., plastic, ceramic, glass, or the like), and may have a first diameter R1.

For example, the head 212 may be disposed at one end of the shaft 211 and may be configured to receive external force. The head 212 may have a second diameter R2 that is greater than the first diameter R1. For example, the head 212 may be a crown of a watch, and may be made of an insulating material similar to that of the shaft 211.

The external force received by the head 212 may include a torque in a direction around the rotation axis (X axis), and may include force in a direction different from the rotation axis (X axis) (e.g., Y direction and/or Z direction). The rotor 210 may rotate according to a torque received by the head 212, and may move according to force in a direction different from that of a rotation axis (X axis) received by the head 212.

For example, when an absolute position of one point of the shaft 211 is fixed, a direction in which the head 212, which is disposed at one end of the shaft 211, moves, and a direction in which the metal contact member 213, which is disposed at the other end of the shaft 211, moves may be opposite to each other.

The metal contact member 213 may be disposed at the other end of the shaft 211, may be made of a metal material, and may have a third diameter R3 that is greater than the first diameter R1.

The metal contact member 213 may be disposed to surround the shaft 211. For example, the metal contact member 213 may be formed through a plating process on the shaft 211, and the metal contact member 213 may be fitted to the shaft 211 in a state of being previously manufactured in a ring shape having an inner diameter corresponding to the first diameter R1 of the shaft 211.

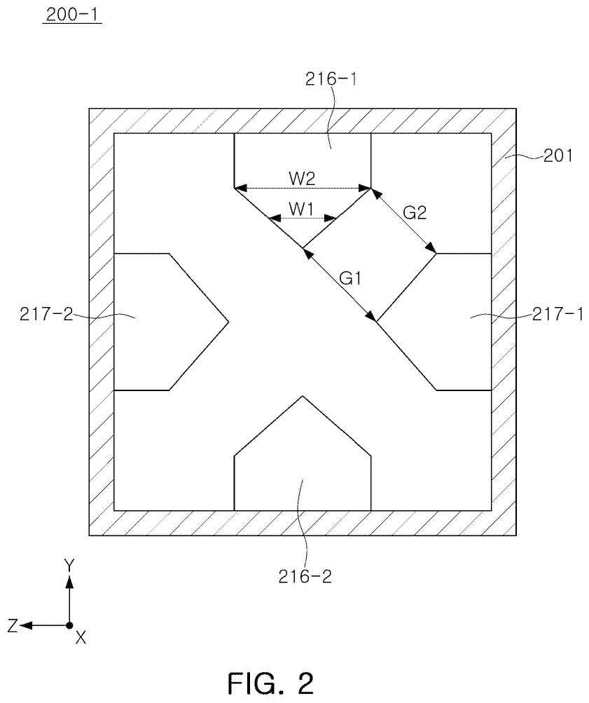

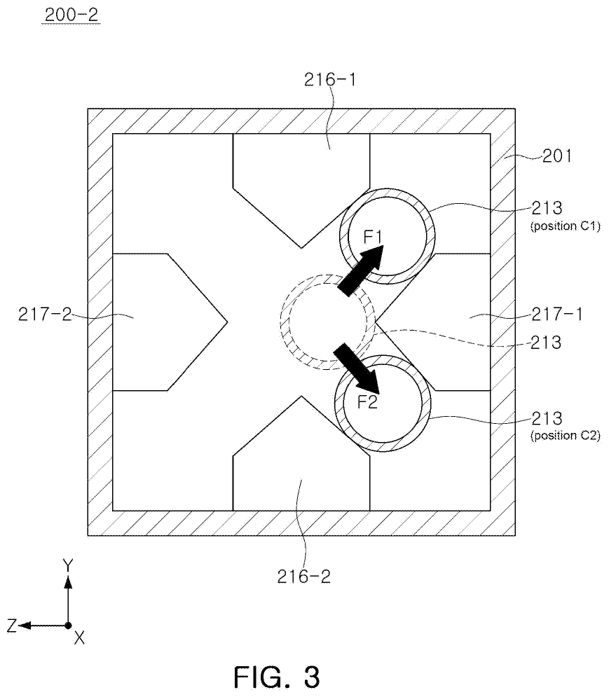

FIG. 2 is a view illustrating an arrangement of first and second electrodes of an apparatus for sensing movement of a rotor (hereinafter, “rotor movement sensing apparatus”), according to an embodiment. FIG. 3 is a view illustrating contact with first and second electrodes according to the movement of the rotor 210 of the rotor movement sensing apparatus, according to an embodiment.

Referring to FIG. 2, a first structure 200-1 without the rotor 210 being disposed in the rotor movement sensing apparatus may include first electrodes 216-1 and 216-2 and second electrodes 217-1 and 217-2, and may further include a housing 201.

Referring to FIG. 3, the second structure 200-2 with the rotor 210 being disposed in the rotor movement sensing apparatus may further include the metal contact member 213. The metal contact member 213 is inserted into an inner space of the housing 201 in the X axis direction while being disposed on the shaft of the rotor 210.

The first electrodes 216-1 and 216-2 and the second electrodes 217-1 and 217-2 may be disposed to be spaced apart from each other and may be arranged to surround a space in which the rotor 210 is to be disposed.

The metal contact member 213 may be disposed on the rotor so as to contact the first and second electrodes 216-1, 216-2, 217-1, and 217-2 together (e.g., at the same time) as the rotor receives force in a direction different from the rotation axis (X axis) (e.g., Y direction and/or Z direction).

The metal contact member 213, when moved to an upper right side in position C1 according to first force F1, may contact the first electrode 216-1 and the second electrode 217-1 together (e.g., at the same time). Accordingly, the first electrode 216-1 and the second electrode 217-1 may be electrically connected to each other through the metal contact member 213.

That is, the electrical connection state between the first and second electrodes 216-1 and 217-1 may be determined according to whether or not the rotor 210 moves as the rotor 210 receives force in a direction different from the rotation axis (X axis).

Different first and second voltages may be periodically or continuously applied to the first and second electrodes 216-1 and 217-1, and a current flowing between the first and second electrodes 216-1 and 217-1 may vary depending on the electrical connection state between the first and second electrodes 216-1 and 217-1, and may vary depending on whether the rotor moves as the rotor 210 receives force in a direction different from the rotation axis (X axis).

Therefore, the rotor movement sensing apparatus may have a structure that efficiently detects movement other than rotation of the rotor 210.

The first electrodes 216-1 and 216-2 are spaced apart from each other, and the second electrodes 217-1 and 217-2 are spaced apart from each other. Although the illustrated embodiment includes two first electrodes 216-1 and 216-2, and two second electrodes 217-1 and 217-2, a plurality of first electrodes including three or more first electrodes and a plurality of second electrodes including three or more second electrodes may be provided. Here, the plurality of first electrodes 216-1 and 216-2 and the plurality of second electrodes 217-1 and 217-2 may be alternately arranged with each other.

The metal member 213, when moved to a lower right side in position C2 according to second force F2, may contact the first and second electrodes 216-2 and 217-1 together (e.g., at the same time).

A rotor movement sensing apparatus having a structure in which the first electrodes 216-1 and 216-2 and the second electrodes 217-1 and 217-2 are alternately arranged with each other may detect that the rotor 210 receives force in various directions, different from the rotation axis (X axis), such that it is possible to stably detect movement other than rotation of the rotor 210, and more precisely detect the direction of the force received by the rotor 210.

For example, as shown in FIG. 2, a distance G1 between one ends of adjacent first and second electrodes, among the plurality of first and second electrodes 216-1, 216-2, 217-1, and 217-2, may be greater than the third diameter R3 of the metal contact member 213, and a distance G2 between corresponding points of respective, opposing side surfaces (e.g., side surfaces that face each other) of adjacent first and second electrodes may be less than or equal to the third diameter R3 of the metal contact member 213.

Accordingly, a maximum distance that the metal contact member 213 can move, may be a distance from an initial position to one point of the side surface of first and second electrodes that face each other, among the plurality of first and second electrodes 216-1, 216-2, 217-1, and 217-2.

Accordingly, a distance range in which the metal contact member 213 can move may be clearly set, and the metal contact member 213 may be prevented from deviating from the distance range when excessive force is applied to the rotor receives. Accordingly, the rotor movement sensing apparatus may be improved, and the possibility of malfunction of the rotor movement sensing apparatus may be reduced.

For example, each of the plurality of first electrodes 216-1 and 216-2 and each of the plurality of second electrodes 217-1 and 217-2 may have a wedge shape. For example, in each of the plurality of first electrodes 216-1 and 216-2 and each of the plurality of second electrodes 217-1 and 217-2, a wedge-shaped first, front width W1 is shorter than a wedge-shaped second, rear width W2.

Accordingly, since the metal contact member 213 can stably slide toward the space between two electrodes that face each other, among the plurality of first and second electrodes 216-1, 216-2, 217-1, and 217-2, durability of the rotor movement sensing apparatus may be further improved, and possibility of the rotor movement sensing apparatus malfunctioning may be further reduced.

For example, the first electrodes 216-1 and 216-2 may have shapes extending in directions facing each other from different positions of the housing 201, and the second electrodes 217-1 and 217-2 may have shapes extending in directions facing each other from different positions of the housing 201. Accordingly, the plurality of first electrodes 216-1 and 216-2 and the plurality of second electrodes 217-1 and 217-2 may be adaptively arranged in the structure of the housing 201 (e.g., a hexahedron). Therefore, the plurality of first electrodes 216-1 and 216-2 and the plurality of second electrodes 217-1 and 217-2 may be more stably disposed in the housing 201.

The housing 201 may be made of an insulating material similar to that of the rotor 210, and may be a part of a main body of an electronic device, or may be coupled to or bonded to the main body.

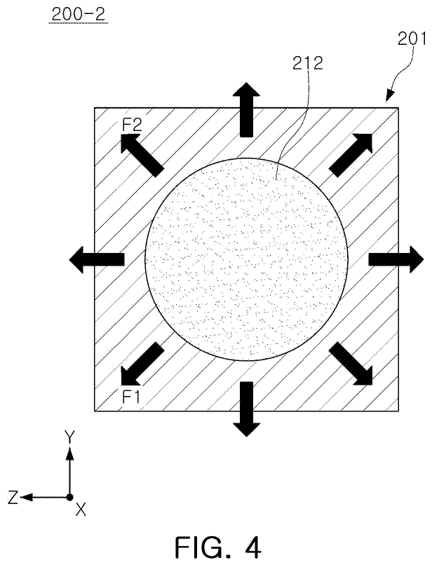

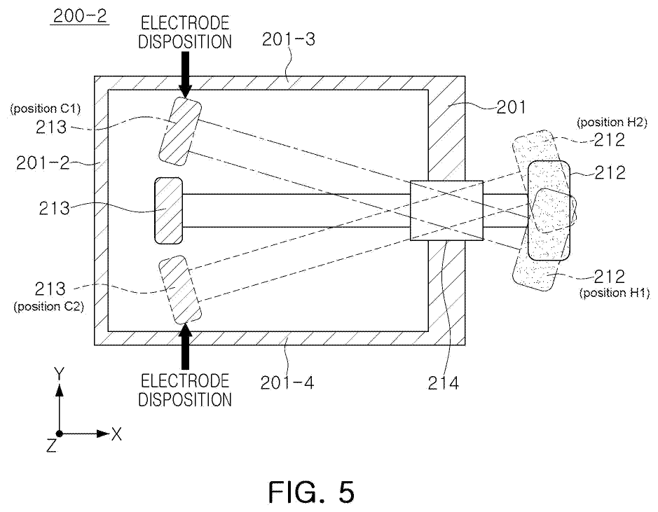

FIGS. 4 and 5 are views illustrating a direction of movement of the rotor 210 of the rotor movement sensing apparatus, according to an embodiment.

Referring to FIG. 4, the head 212 of the rotor 210 may move by receiving the first force F1 or the second force F2 from the outside, and may also move by receiving first force F1 or second force F2 in a direction different from the directions of the first and second forces F1 and F2.

Referring to FIG. 5, the head 212, when receiving the first force F1, may be positioned biased in a −Y direction, in a first position H1, and the metal contact member 213, when receiving the first force F1, may be positioned biased in a +Y direction, in the first position C1. The head 212, when receiving the second force F2, may be positioned biased in the +Y direction, in a second position H2, and the metal contact member 213, when receiving the second force F2, may be positioned biased in the −Y direction, in the second direction C2.

The rotor 210 may be disposed to penetrate through a through-hole of the housing 201, and an absolute position of one point of the rotor may be fixed to the through-hole of the housing 201.

The fixing member 214 may be disposed in the through-hole, and may be configured to prevent movement in the same direction as the rotation axis (X axis) of the rotor 210. Accordingly, contact stability between the metal contact member 213 and the electrode may be improved.

In addition, the fixing member 214 may have elastic force so that the head 212 and the metal contact member 213 are not biased in they direction when the rotor is not subjected to external force.

For example, a plurality of grooves may be formed at one point of the rotor, and the fixing member 214 may include a plurality of protruding portions respectively inserted into the plurality of grooves. The plurality of grooves may be formed to surround the rotation axis (X axis) of the rotor 210.

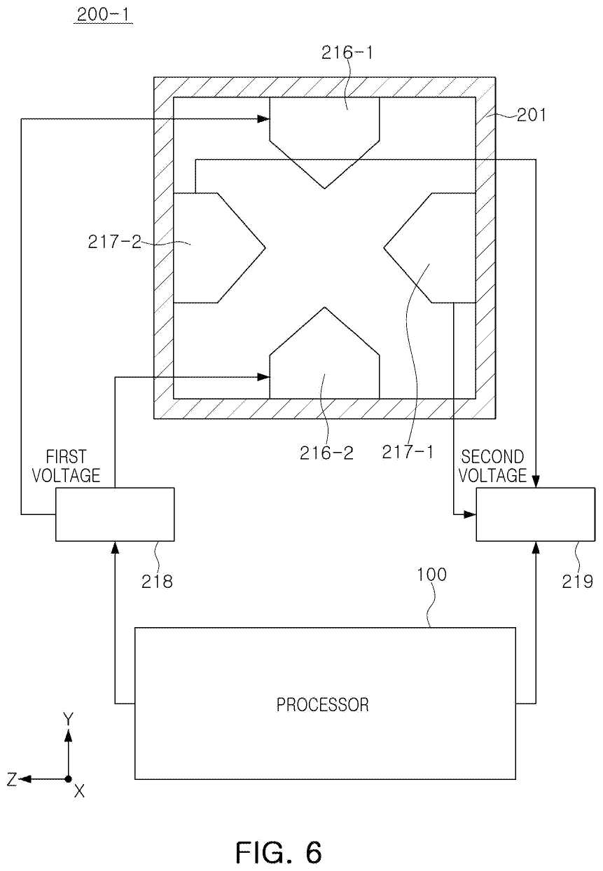

FIG. 6 is a view illustrating a structure for generating information dependent on an electrical connection state between the first and second electrodes 216-1, 216-2, 217-1, and 217-2 of the rotor movement sensing apparatus, according to an embodiment.

Referring to FIG. 6, the rotor movement sensing apparatus may further include a processor 100, and may be electrically connected to the first and second electrodes 216-1, 216-2, 217-1, and 217-2 through a first terminal 218 and a second terminal 219.

For example, the processor 100 may include a central processing unit (CPU), a graphics processing unit (GPU), a microprocessor, an application specific integrated circuit (ASIC), a field programmable gate array (FPGA), and the like, and may include a plurality of cores. The processor 100 may input and output information for a storage element and a communication element.

The processor 100 may be configured to generate information dependent on an electrical connection state between the first and second electrodes 216-1, 216-2, 217-1, and 217-2.

For example, the processor 100 may generate a control signal for a circuit configured to generate first and second voltages, and the circuit may generate the first and second voltages based on the control signal to output the first and second voltages to the first terminal 218 and the second terminal 219. The circuit may detect currents of the first terminal 218 and the second terminal 219, and may generate a sensing signal based on a current detection result (e.g., a magnitude relationship between a sensing current and a reference current). The processor 100 may generate information based on the detection signal.

For example, the first terminal 218 and the second terminal 219 may be disposed on an outer surface of the housing 201, or in a main body of an electronic device, or on a substrate. The housing 201 may include wires electrically connecting the first terminal 218 to the first electrodes 216-1 and 216-2, and connecting the second terminal 219 to the second electrodes 217-1 and 217-2.

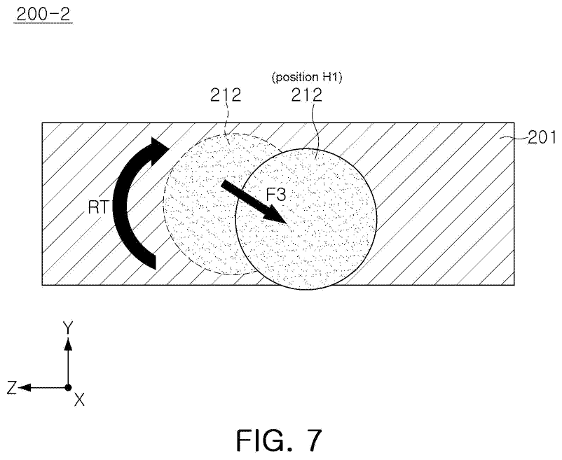

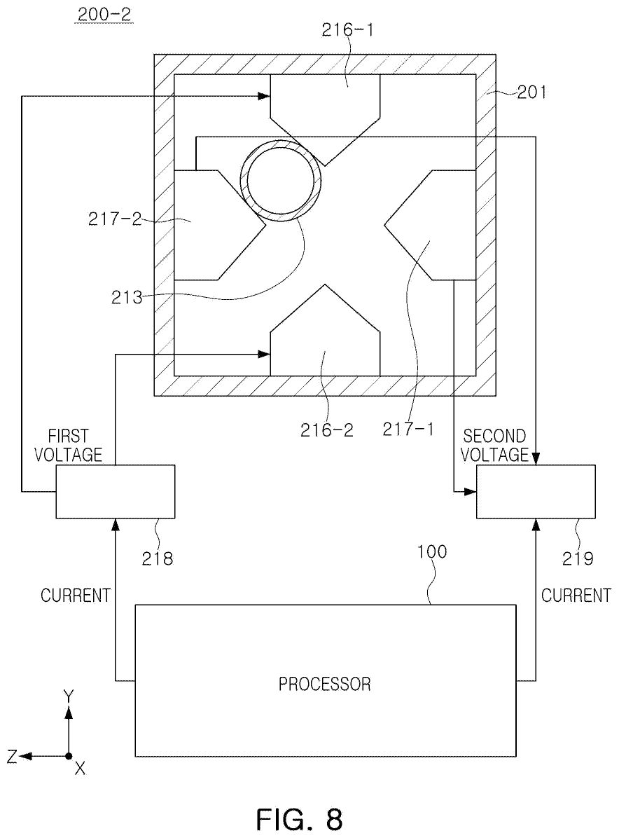

FIGS. 7 and 8 are views illustrating contact with the first and second electrodes of the rotor movement sensing apparatus, according to an embodiment.

Referring to FIG. 7, the head 212 of the rotor 210 may rotate by receiving a torque RT, and may move according to third force F3.

Referring to FIG. 8, when the metal contact member 213 of the rotor moves and contacts the first and second electrodes 216-1 and 217-2 together (e.g., at the same time), a current according to the first and second voltages may be greater than a reference current, and the processor 100 may generate information based on the current between the first and second terminals 218 and 219.

For example, the processor 100 may control a display member that outputs display information based on the information.

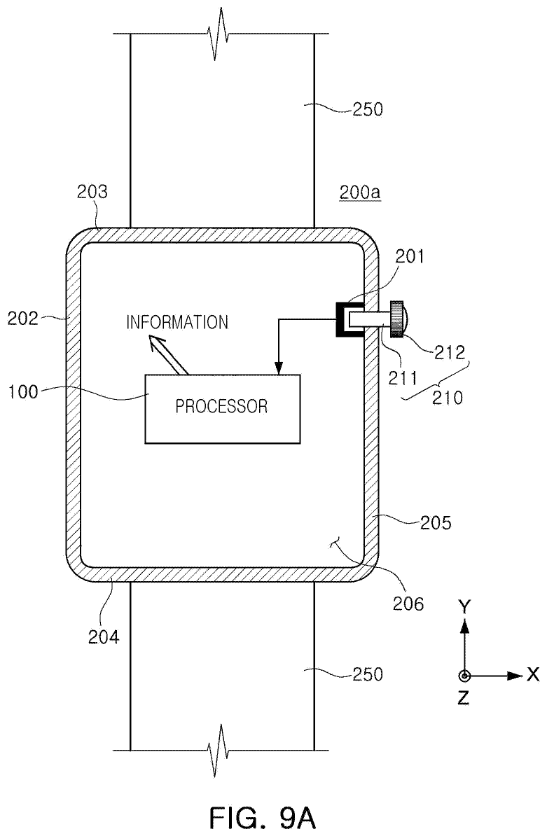

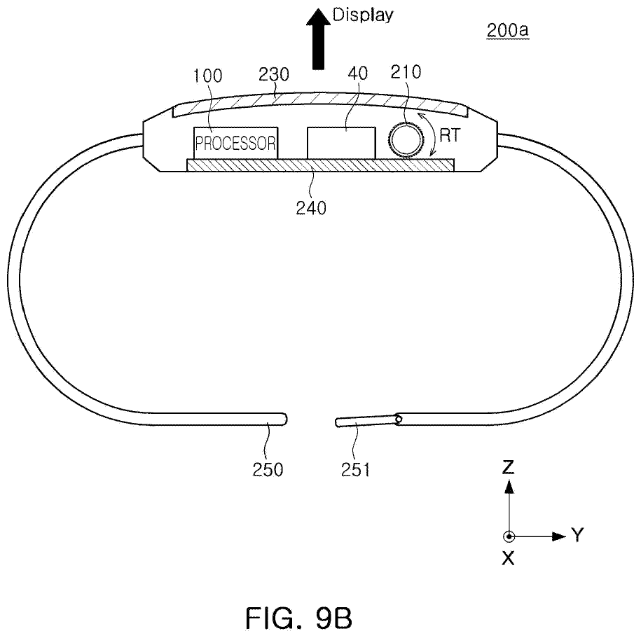

FIGS. 9A and 9B are views illustrating an electronic device 200a, according to an embodiment.

Referring to FIGS. 9A and 9B, the electronic device 200a may include, for example, a main body including at least two of a first surface 205, a second surface 202, a third surface 203, and a fourth surface 204. The processor 100 may be disposed in an internal space 206 of the main body.

For example, the electronic device 200a may be a smartwatch, a smartphone, a personal digital assistant, a digital video camera, a digital still camera, a network system, a computer, a monitor, a tablet, a laptop, a netbook, a television, a video game, an automotive component, or the like, but is not limited thereto.

The electronic device 200a may include the processor 100, and a storage element, such as a memory or a storage, configured to store information, as well as a communication element, such as a communication modem or an antenna, configured to remotely transmit and receive the information.

The processor 100 may receive various types of movement information according to at least one combination of rotation angle information and rotation axis vertical information of the rotor 210, and may generate various types of electronic device movement information based on the movement information of the rotor 210. For example, the main body of the electronic device 200a may output first display information based on the rotation angle of the rotor 210, and second display information based on a translational motion of the rotor 210.

Referring to FIGS. 9A and 9B, the electronic device 200a may further include a strap 250 connected to at least one of the first, second, third and fourth surfaces 205, 202, 203, and 204 of the main body and is more flexible than the main body.

Accordingly, since the strap 250 can be worn over a user's body (or an article of clothing) of the electronic device 200a, the user can use the electronic device 200a more conveniently. For example, one end and the other end of the strap 250 may be coupled through a coupling portion 251.

Referring to FIG. 9B, the electronic device 200a may include a display member 230 and a substrate 240, and may further include a rotation information calculation portion 40.

The display member 230 may output display information in a normal direction of the main body (e.g., Z direction), different from a normal direction (e.g., X direction and/or Y direction) of the first, second, third and fourth surfaces 205, 202, 203, 204 of the main body. The normal direction of the display member 230 and the normal direction of the display surface of the main body of the electronic device 200a may be the same as each other.

At least a portion of the display information output by the display member 230 may be based on information generated by a processor 100. That is, the processor 100 may transmit display information based on the information to the display member 230.

For example, the display member 230 may have a structure in which a plurality of display cells are arranged in two dimensions, may receive a plurality of control signals based on the electronic device operation information from the processor 100 or a separate processor, and the plurality of display cells may be configured to determine whether to display and/or a color to display based on a plurality of control signals. For example, the display member 230 may further include a touch screen panel, and may be implemented with a relatively flexible material such as OLED.

The substrate 240 may provide a dispositional space for the processor 100 and may provide an information transmission path between the processor 100 and the display member 230. For example, the substrate 240 may be implemented as a printed circuit board (PCB).

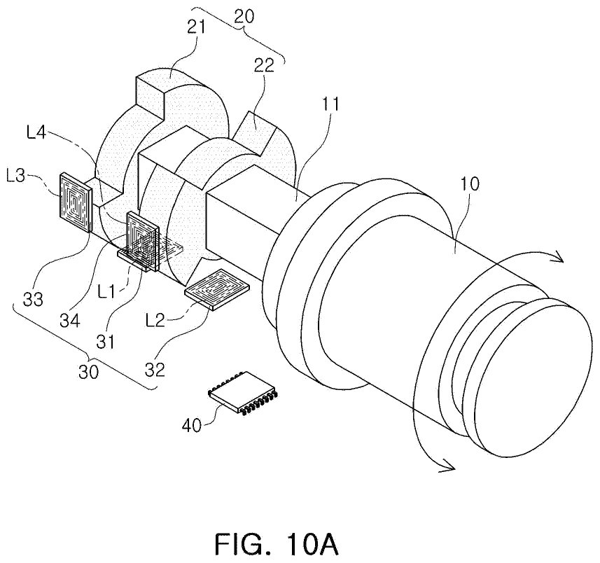

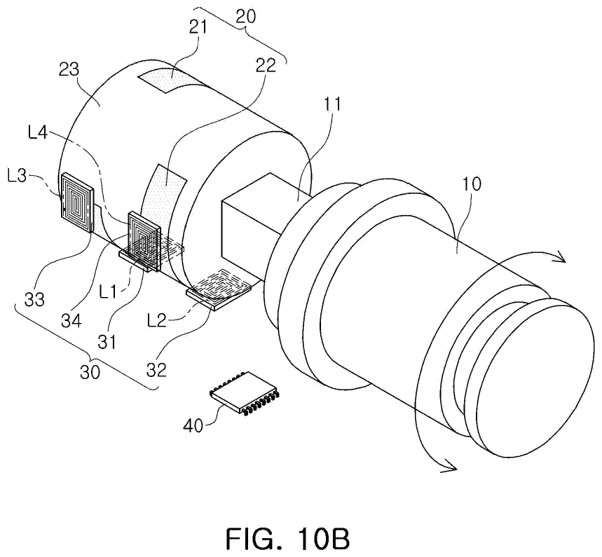

The rotation information calculation portion 40 may be electrically connected to a rotation sensor portion 30 shown in FIGS. 10A and 10B, and may calculate rotation information dependent on a rotation angle of the rotor 210 based on inductance of a sensing coil of the rotation sensor portion 30. The processor 100 may generate information dependent on the rotation information.

FIGS. 10A and 10B are views illustrating a rotor movement sensing and rotor rotation angle detecting apparatus according to an embodiment of the present disclosure.

Referring to FIGS. 10A and 10B, a rotor may include a wheel 10, a rotation axis 11, and a detected portion 20, and an apparatus for sensing movement of a rotor and an electronic device according to an embodiment of the present disclosure may include the rotation sensor portion 30 and the rotation information calculation portion 40.

The detected portion 20 may be connected to the wheel 10 through the rotation axis 11. It may be understood that the wheel 10 is employed in an electronic device, and is a rotor portion that is rotated in a clockwise or counterclockwise direction by a user. The detected portion 20 may rotate in a clockwise or counterclockwise direction together with the wheel 10.

The detected portion 20 may include a first pattern portion 21 and a second pattern portion 22. The first pattern portion 21 and the second pattern portion 22 may be formed in the same shape, may be spaced apart by a predetermined distance along the extending direction of the rotation axis 11, and may be coupled to the rotation axis 11. The first pattern portion 21 and the second pattern portion 22 coupled to the rotation axis may rotate in the same direction and at the same speed when the rotor rotates.

Each of the first pattern portion 21 and the second pattern portion 22 may include a plurality of patterns having the same shape. The first pattern portion 21 includes a plurality of first patterns, and the second pattern portion 22 includes a plurality of second patterns.

In FIG. 10A, a protruding region of the first pattern portion 21 and the second pattern portion 22 corresponds to a pattern. For example, the plurality of first patterns of the first pattern portion 21 and the plurality of second patterns of the second pattern portion 22 may be manufactured by processing disk-shaped metal and a magnetic material to form saw teeth. Therefore, the plurality of first patterns of the first pattern portion 21 and the plurality of second patterns of the second pattern portion 22 may be formed of one of metal and a magnetic material.

The plurality of first patterns of the first pattern portion 21 extend along the rotation direction, and the plurality of second patterns of the second pattern portion 22 extend along the rotation direction. The length that each of the first patterns extends in the rotation direction may be defined as a size of the first pattern, and the length that each of the second patterns extends in the rotation direction may be defined as a size of the second pattern.

The plurality of first patterns of the first pattern portion 21 are disposed to be spaced apart by a predetermined distance in the rotation direction, and the plurality of second patterns of the second pattern part 22 are disposed to be spaced apart by a predetermined distance in the rotation direction. As an example, the separation distance of the plurality of first patterns of the first pattern portion 21 may be the same as the size of the first pattern, and the separation distance of the plurality of second patterns of the second pattern portions 22 may be the same as the size of the second patterns 22.

As an example, the plurality of first patterns of the first pattern portion 21 and the plurality of second patterns of the second pattern portion 22 may be disposed to have an angular disposition difference corresponding to half the size of each first pattern and half the size of each second pattern.

Assuming that the first pattern portion 21 has two first patterns having an angular position difference of 90°, and the second pattern portion 22 has two second patterns having an angular position difference of 90°, the plurality of first patterns of the first pattern portion 21 and the plurality of second patterns of the second pattern portion 22 may be disposed to have an angular position difference of 45°. Therefore, the plurality of first patterns of the first pattern portion 21 and the plurality of second patterns of the second pattern portion 21 may overlap in some regions in a direction in which the rotation axis 11 extends.

The rotation sensor portion 30 may include a plurality of sensors. For example, the sensor portion 30 may include a first rotation sensor 31, a second rotation sensor 32, a third rotation sensor 33, and a fourth rotation sensor 34. The first rotation sensor 31 and the second rotation sensor 32 are disposed on a first plane along an extending direction of the rotation axis 11. The first rotation sensor 31 is disposed to face the first pattern portion 21, and the second rotation sensor 32 is disposed to face the second pattern portion 22. In addition, the third rotation sensor 33 and the fourth rotation sensor 34 are disposed on a second plane in the extending direction of the rotation axis 11. The third rotation sensor 33 is disposed to face the first pattern portion 21, and the fourth rotation sensor 34 is disposed to face the second pattern portion 22. The first plane and the second plane may be disposed to have a predetermined angle.

By the rotation of the first pattern portion 21 and the second pattern portion 22, an area of the first rotation sensor 31 and the third rotation sensor 33 overlapping the first pattern of the first pattern portion 21 is changed, and an area of the second rotation sensor 32 and the fourth rotation sensor 34 overlapping the second pattern of the second pattern portion 22 is changed. The first rotation sensor 31 and the third rotation sensor 33 may detect a change in an overlapping area with the first pattern portion 21, and may detect a change in an overlapping area with the second pattern portion 22.

The first rotation sensor 31, the second rotation sensor 32, the third rotation sensor 33, and the fourth rotation sensor 34 may have predetermined sizes. Here, sizes of the first rotation sensor 31, the second rotation sensor 32, the third rotation sensor 33, and the fourth rotation sensor 34 will be understood as a length corresponding to the direction in which the rotor rotates. For example, the sizes of the first rotation sensor 31, the second rotation sensor 32, the third rotation sensor 33, and the fourth rotation sensor 34 may correspond to half the sizes of the first pattern of the first pattern portion 21 and the second pattern of the second pattern portion 22.

Due to an angular position difference between the first pattern portion 21 and the second pattern portion 22 described above, a sensing value output from the first rotation sensor 31 and a sensing value output from the second rotation sensor 32 may have a phase difference of 90°. In addition, a sensing value output from the third rotation sensor 33 and a sensing value output from the fourth rotation sensor 34 may have a phase difference of 90°.

The first rotation sensor 31 and the third rotation sensor 33 may be disposed to have an angular position difference equal to the size of the first pattern, and the second rotation sensor 32 and the fourth rotation sensor 34 may be disposed to have an angular position difference equal to the size of the second pattern. The first rotation sensor 31 and the third rotation sensor 33 may be disposed to have an angular position difference equal to the size of the first pattern, such that a sensing value output from the first rotation sensor 31 and a sensing value output from the third rotation sensor 33 may have a phase difference of 180°.

The first rotation sensor 31, the second rotation sensor 32, the third rotation sensor 33, and the fourth rotation sensor 34 may include sensing coils L1, L2, L3, and L4, respectively. The sensing coils L1, L2, L3, and L4 may be provided by forming a circuit pattern on a substrate. According to an embodiment, the sensing coils L1, L2, L3, and L4 may be formed of one of a wound-type inductor coil and a solenoid coil. The first rotation sensor 31, the second rotation sensor 32, the third rotation sensor 33, and the fourth rotation sensor 34 including the sensing coils L1, L2, L3, and L4 may sense the rotation angle and the rotation direction according to inductance that changes according to the overlapping area with the first pattern portion 21 and the second pattern portion 22.

The rotation information calculation portion 40 may be implemented as an integrated circuit, to be electrically connected to the first rotation sensor 31, the second rotation sensor 32, the third rotation sensor 33, and the fourth rotation sensor 34. The rotation information calculation portion 40 may calculate rotation information including the rotation direction and the rotation angle of the rotor according to the change in the inductance of the first rotation sensor 31, the second rotation sensor 32, the third rotation sensor 33, and the fourth sensor 34.

The rotor may further include the metal contact member 213 described above with respect to the embodiments of FIGS. 1 to 8, for example.

Referring to FIG. 10B, a rotor movement sensing and rotor rotation angle detecting apparatus may further include a support member 23 connected to the rotation axis 11. Since the rotor movement sensing and rotor rotation angle detecting apparatus of FIG. 10B is similar to the rotor movement sensing and rotor rotation angle detecting apparatus of FIG. 10A, overlapping descriptions thereof will be omitted and the differences will be mainly described.

The support member 23 may be connected to the rotation axis 11, and may rotate around the rotation axis 11 in a clockwise or counterclockwise direction according to the rotation of the wheel 10. For example, the support member 23 may be formed in a cylindrical shape. The detected portion 20 may be disposed on the support member 23 having the cylindrical shape. The detected portion 20 may include the first pattern portion 21 and the second pattern portion 22 disposed on a side surface of the support member 23 having the cylindrical shape.

The first pattern portion 21 may include the plurality of first patterns extending in a rotation direction in a first height region of the support member 23, and the second pattern portion 22 may include the plurality of second patterns extending in the rotation direction in the second height region of the support member 23. The plurality of first patterns of the first pattern portion 21 and the plurality of second patterns of the second pattern portion 22 may be formed of one of metal and a magnetic material.

The support member 23 may be formed of a non-metallic material such as plastic, and the first pattern portion 21 and the second pattern portion 22 may be formed of metal. The support member 23 may be made of plastic through an injection molding process, and the first pattern portion 21 and the second pattern portion 22 may be formed through a plating process.

The first pattern portion 21 and the second pattern portion 22 may be disposed on a side surface of the support member 23. When the first pattern portion 21 and the second pattern portion 22 are disposed on the support member 23, a groove for providing the first pattern portion 21 and the second pattern portion is formed on the side surface of the support member 23 having the cylindrical shape. For example, a step may be provided in the support member 23 by a groove extending along a rotation direction. For example, the step may be provided in the support member 23 by a groove extending along a rotation direction. The first pattern portion 21 and the second pattern portion 22 may be disposed in the groove formed on the side surface of the support member 23, to be exposed externally. For example, the thickness of the first pattern portion 21 and the second pattern portion 22 may be the same as the thickness of the groove.

The rotor movement sensing and rotor rotation angle detecting apparatus according to the embodiment of FIG. 10B may be advantageous in mass production and cost reduction, by employing manufacturing of a thin pattern by a method having excellent mass productivity, such as an injection molding process and a plating process.

As set forth above, according to embodiments described herein, an apparatus for sensing movement of a rotor and an electronic device may have a structure that can effectively detect movement other than rotation of the rotor.

The controller 100 and the rotation information calculation portion 40 in FIGS. 1 to 10B that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1 to 10B that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for sensing movement of a rotor, comprising:
a rotor configured to rotate along a rotation axis;
a first electrode and a second electrode disposed to be spaced apart from each other and arranged to surround the rotation axis; and
a conductive contact member disposed on the rotor and configured to contact the first and second electrodes as the rotor receives force in a direction different from a direction of the rotation axis.

2. The apparatus of claim 1, wherein the first electrode comprises a plurality of first electrodes spaced apart from each other,
wherein the second electrode comprises a plurality of second electrodes spaced apart from each other, and
wherein the plurality of first electrodes and the plurality of second electrodes are alternately arranged with each other.

3. The apparatus of claim 2, wherein the plurality of first electrodes have shapes extending in directions facing each other from different positions, and
the plurality of second electrodes have shapes extending in directions facing each other from different positions.

4. The apparatus of claim 2, wherein a distance between first ends of adjacent first and second electrodes among the plurality of first electrodes and the plurality of second electrodes is greater than a diameter of the conductive contact member, and
wherein a distance between corresponding points of respective side surfaces of the adjacent first and second electrodes that face each other is less than or equal to the diameter of the conductive contact member.

5. The apparatus of claim 4, wherein each of the plurality of first electrodes is wedge-shaped, and each of the plurality of second electrodes is wedge-shaped.

6. The apparatus of claim 1, further comprising a housing forming a space in which the first electrode and the second electrode are disposed, and having a through-hole through which the rotor penetrates.

7. The apparatus of claim 6, wherein the rotor comprises a shaft disposed to penetrate through the through-hole, and a head disposed at one end of the shaft and configured to receive external force, and
wherein the conductive contact member is disposed at another end of the shaft.

8. The apparatus of claim 7, wherein the conductive contact member is disposed to surround the other end of the shaft.

9. The apparatus of claim 7, further comprising a fixing member disposed in the through-hole and configured to prevent movement of the shaft in the direction of the rotation axis.

10. The apparatus of claim 1, wherein the conductive contact member is further configured to contact the first and second electrodes at a same time as the rotor receives the force in the direction different from the direction of the rotation axis.

11. An electronic device, comprising:
a main body;
a rotor disposed on one surface of the main body and having a rotation axis extending toward the main body;
a first electrode and a second electrode disposed to be spaced apart from each other and arranged to surround the rotor;
a conductive contact member disposed on the rotor and configured to contact the first and second electrodes at a same time as the rotor receives force in a direction different from a direction of the rotation axis; and
a processor disposed in the main body and configured to generate information dependent on an electrical connection state between the first and second electrodes.

12. The electronic device of claim 11, wherein the main body includes a display surface for outputting display information, and
wherein the one surface of the main body is configured to have a normal direction different from a normal direction of the display surface.

13. The electronic device of claim 12, wherein at least a portion of the display information is based on the information dependent on the electrical connection state between the first and second electrodes.

14. The electronic device of claim 12, further comprising a fixing member disposed on the main body and configured to prevent the movement of the rotor in the direction of the rotation axis.

15. The electronic device of claim 14, further comprising a sensing coil disposed such that an inductance varies according to a rotation angle of the rotor,
wherein the processor is further configured to generate information dependent on the rotation angle of the rotor based on the inductance.

16. The electronic device of claim 11, wherein the first electrode comprises a plurality of first electrodes spaced apart from each other,
wherein the second electrode comprises a plurality of second electrodes spaced apart from each other, and
wherein the plurality of first electrodes and the plurality of second electrodes are alternately arranged with each other.

17. The electronic device of claim 16, wherein a distance between first ends of adjacent first and second electrodes among the plurality of first electrodes and the plurality of second electrodes is greater than a diameter of the conductive contact member, and
wherein a distance between corresponding points of respective side surfaces of the adjacent first and second electrodes that face each other is less than or equal to the diameter of the conductive contact member.

18. The electronic device of claim 12, wherein the first electrode and the second electrode are wedge-shaped.

19. The electronic device of claim 12, wherein the conductive contact member is configured to be moved between the first and second electrodes as the rotor receives the force, and
wherein the first and second electrodes are configured to limit a distance the conductive contact member is moved between the first and second electrodes.
